(19) United States
(12) Patent Application Publication
(10) Pub. No.: US 2022/0338656 A1
(43) Pub. Date: Oct. 27, 2022

(54) HANGING DEVICE

(71) Applicant: Avery Dennison Retail Information Services LLC, Mentor, OH (US)

(72) Inventors: Caroline HUGHES, Nottingham (GB); Daniel KENNEDY, Northampton (GB); Nicholas PHILLIPS-MOUL, Nottingham (GB)

(21) Appl. No.: 17/620,864

(22) PCT Filed: Jul. 2, 2020
(86) PCT No.: PCT/US2020/040689

§ 371 Date: Dec. 20, 2021

Related U.S. Application Data
(60) Provisional application No. 62/870,914, filed on Jul. 5, 2019.

(51) Int. Cl. A47G 25/14; B32B 7/12; B32B 3/26; B32B 3/30; B32B 29/00

(52) U.S. Cl. CPC A47G 25/14; B32B 7/12; B32B 3/266; B32B 3/30; B32B 29/005; B32B 2307/4026; B32B 2255/12; B32B 2250/26

(57) ABSTRACT

A hanging device and methods of making the hanging device are shown and described herein. The hanging device may be a hook or a hanging device. The hanging device comprises: a) a first outer liner; b) at least one inner layer; and c) a second outer liner. For the hanging device, the first outer liner is at least partially disposed on the at least one inner layer and the second outer liner is at least partially disposed on the at least one inner layer, and the first outer liner, the at least one inner layer, and the second outer liner are laminated together. The hanging device may be comprised of a biobased material and/or a recycled material. The hanging device may be biodegradable.

### CROSS REFERENCE TO RELATED APPLICATION(S)

The present application claims priority to and the benefit of U.S. provisional patent application No. 62/870,914 filed Jul. 5, 2019, which is incorporated herein by reference in its entirety.

### FIELD

The present disclosure relates generally to hanging device products, and more particularly to hanging devices that are comprised of multi-layered constructions. The hanging devices described herein may be particularly suitable for use with retail items such as clothing, clothing accessories (e.g., neck ties, scarves, belts, etc.) footwear, and the like. Further, the hanging devices may be comprised of a biobased material and/or a recycled material.

### BACKGROUND

It is estimated that billions of product hanging devices are disposed of annually, and that only a small percentage of those product hanging devices are successfully recycled. Most such hanging devices are comprised of metal or plastic, each of which have their benefits and limitations. In some instances, product hanging devices may be made of a combination of both metal and plastic.

Metal hanging devices, such as wire hanging devices, copper hanging devices, stainless steel hanging devices, aluminum hanging devices, etc., can typically withstand heavier loads and have a relatively long service life. However, such metal hanging devices are also relatively expensive to manufacture and ship, due to their weight, and their production tends to have a greater negative impact on the environment.

Plastic hanging devices, on the other hand, are typically comprised of an acrylonitrile butadiene styrene (ABS) copolymer, polypropylene, polystyrene, etc. Compared to metal hanging devices, plastic hanging devices are lighter and less expensive to manufacture and ship. However, plastic hanging devices also tend to be less sturdy, and their production tends to have a greater negative impact on the environment than hanging devices manufactured from other, more environmentally friendly materials. Further, the ability and practicality of recycling plastic hanging devices will depend on the type of plastic used. For example, it is not always desirable, efficient and/or practical to recycle plastic hanging devices made of polystyrene. Furthermore, because article hanging devices may be made from different types of plastic and include multiple materials (such as metal hooks and clips, vinyl and rubber padding to prevent slipping), most recovery programs have banned recycling of plastic article hanging devices. Unfortunately, retailers may simply choose to dispose of the plastic article hanging devices without recycling. As a result, the plastic article hanging devices typically end up in landfills.

Given the limitations associated with metal and plastic hanging devices, attempts have been made to produce hanging devices comprised of paper materials. However, such efforts have resulted in hanging devices that do not provide enough support to become acceptable substitutes to metal and plastic hanging devices, especially in retail markets. In some instances, once a weak spot is formed in the hook portion of an all paper hanging device, structural failure typically results fairly quickly. Further, hanging devices comprised of all paper construction typically cannot be used with standard dry cleaning equipment because the hanging devices will tear, shred and/or otherwise deteriorate in the presence of heat, moisture, dry cleaning chemicals and/or combinations thereof.

In view of these conventional technologies, the need therefore remains for an improved hanging device with enhanced performance characteristics that is also environmentally friendly, easy to use, and recyclable. There also exists in the art a long felt need for a product hanging device that can be manufactured at a relatively low cost, and in a wide variety of shapes, sizes and orientations to suit user need and/or preference.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later, and the embodiments are chosen and described so that others skilled in the art may appreciate and understand the principles and practices of the present disclosure.

A hanging device and methods of making the hanging device are shown and described herein. In many embodiments, the hanging device is a hook or a hanging device. The hanging device may comprise: a) a first outer liner; b) at least one inner layer; and c) a second outer liner. For the hanging device, the first outer liner may be at least partially disposed on the at least one inner layer and the second outer liner may be at least partially disposed on the at least one inner layer. For the hanging device, the first outer liner, the at least one inner layer, and the second outer liner may be laminated together.

In many embodiments, the first outer liner, the at least one inner layer, and the second outer liner are laminated together using a laminate adhesive. In some embodiments, the laminate adhesive is comprised of at least one of the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive. In some embodiments, the laminate adhesive is comprised of a pressure sensitive adhesive.

In many embodiments, the hanging device may be comprised of a biobased material and/or a recycled material. In many embodiments, the hanging device may be biodegradable. In many embodiments, the first outer liner, the at least one inner layer, and the second outer liner may be comprised of pulp board, paper board, corrugated fiber board, mat board, paper board, kraft paper, kraft board, cardstock, vellum, newsprint, wax impregnated papers, cardboard, cellulose fibers, or combinations thereof.

Also described are methods of assembling the hanging device described herein.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 depicts a perspective view of a hanging device in accordance with embodiments of the disclosure;

FIG. 2 depicts of one potential embodiment of a hanging device in accordance with the disclosed architecture.

FIG. 3 depicts of one potential embodiment of a hanging device in accordance with the disclosed architecture.

FIG. 4 depicts of one potential embodiment of a hanging device in accordance with the disclosed architecture.

FIG. 5 depicts of one potential embodiment of a hanging device in accordance with the disclosed architecture.

FIG. 6 depicts of one potential embodiment of a hanging device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

It will thus be seen according to the present disclosure a highly advantageous object for hanging or carrying an article has been provided. The disclosure is not to be limited to the disclosed embodiments, and that many modifications and equivalent arrangements may be made thereof within the scope of the disclosure, which scope is to be accorded the broadest interpretation of the appended claims so as to encompass all equivalent structures and products.

Described herein is a hanging device. The hanging device may be used for a variety of applications. The subject matter disclosed and claimed herein, in one aspect thereof, comprises a hanging device for supporting an article. In many embodiments, the article may include an article of clothing. In some embodiments, the article of clothing may include more than one article of clothing. The articles may include but are not limited to socks, scarves, hosiery, hair accessories, ties, undergarments, footwear, glasses, belts, and other clothing. Further, the hanging device may come in a wide variety of different shapes, sizes and configurations to suit user need and/or preference, or a particular product configuration.

A hanging device may comprise: (a) a first outer liner; (b) at least one inner layer; and (c) a second outer liner; wherein the first outer liner is at least partially disposed on the at least one inner layer; wherein the second outer liner is at least partially disposed on the at least one inner layer; wherein the first outer liner, the at least one inner layer, and the second outer liner are laminated together; and wherein the hanging device is a hook or a hanging device.

### Construction

In many embodiments, the first outer liner, the at least one inner layer, and the second outer liner comprises pulp board, paper board, corrugated fiber board, mat board, paper board, kraft paper, kraft board, cardstock, vellum, newsprint, wax impregnated papers, cardboard, cellulose fibers, or combinations thereof.

In particular, paperboard is a paper-based material that is generally thicker (usually over 0.30 mm, 0.012 in, or 12 points) than paper, and has certain superior attributes such as foldability and rigidity. Paper board can also be easily cut (e.g., die cut) and formed, and is relatively lightweight. According to the International Organization for Standardization (ISO), generally stated, paperboard is a paper with a grammage above 250 g/m2 and may be single- or multi-ply.

Further, pulp board may be produced on pulping machines that can handle higher grammage and several plies. Multi-ply paper board, which may be used in the hanging device described herein, generally have higher creasing and folding performance than single-ply as a result of layering different types of pulp into a single product. In cases where the same kind of pulp is being used in several layers, each separate layer is treated and shaped individually in order to create the highest possible quality.

In some embodiments, at least one of the first outer liner and the second outer liner is comprised of a durable paperboard such as 400P Kraft board or 337G Kraft board. By way of background, kraft board can be generally described as a strong virgin fiber board that is often clay-coated to receive printing or other ornamentation. Nonetheless, it is also contemplated that first outer liner and/or the second outer liner may be comprised of other suitable fibrous materials such as fresh (virgin) sources (e.g. wood) or recycled waste paper.

Other raw materials that may be used for the first outer liner, the at least one inner layer, and the second outer liner include, but are not limited to, hardwoods, softwoods, recyclables, and other organic materials. For example, hardwoods such as birch tend to have relatively short fibers that exhibit relatively high tensile strength, but lower tear and other strength properties. Hardwood fibers tend to make for a stiffer product, and make a smoother paper that is more opaque and better for receiving printing.

By comparison, softwoods such as pine and spruce tend to have longer fibers that make for superior paperboard in applications where strength is important. For example, softwoods make excellent linerboard in corrugated cardboard containers. In the case of recyclables, used paper and paper products are collected and sorted, and usually mixed with virgin fibers in order to manufacture the recycled material. This is typically necessary because recycled fibers tend to lose strength when reused, and the added virgin fibers help to compensate for the loss of strength. Further, mixed waste paper is typically not deinked (skipping the deinking stage) for paperboard manufacture and therefore the pulp may contain traces of inks, adhesives, and other residues which together give it a grayish color. Products made of recycled board usually have a less predictable composition and poorer functional properties than virgin fiber-based boards, and the addition of virgin materials helps to alleviate or counterbalance some of these deficiencies.

Similarly, the at least one inner layer may be comprised of durable paperboard such as 500P Kraft board, 550P Kraft board, 1450G Chipboard or the like, and second outer liner 154 may be comprised of a durable paperboard such as 400P Kraft board, 337G Kraft board, or the like.

In some embodiments, the hanging device described herein may be a multi-layered hanging device with the first outer liner, the at least one inner layer, and the second outer liner that may be constructed of virgin materials or recycled materials, or a combination thereof. As described herein, virgin materials may be new materials processed from their sources where they have not been used in previous articles or other products. As described herein, recycled materials may be materials derived from sources of previous articles or other products. In many embodiments, the hanging device may include both virgin materials and recycled materials that can be later recycled, which will aid in reducing the amount of waste materials received by landfills when article hangers, such as clothes hangers, are discarded.

In some embodiments, the first outer liner and the second outer liner may be comprised of the same material. In other embodiments, the first outer liner and the second outer liner may be comprised of different materials.

In some embodiments, the first outer liner, the at least one inner layer, and the second outer liner are substantially the same shape. In other embodiments, the first outer liner, the at least one inner layer, and the second outer liner may be different shapes.

### Hook

In some embodiments, the hanging device may be a hook. A hook, as described herein, refers to an object for catching a hold of or hanging things. In many embodiments, the hook comprises a first portion and a central portion. In many embodiments, the hooked portion is the first portion. In many embodiments, the hooked portion of the hook is curved or bent back at angle, and the other end of the hook may be used to attach to an article through the use of an additional packaging component. In some embodiments, the central portion further comprises a first arm and a second arm. In many embodiments, the additional packaging component may include but is not limited to fasteners or adhesive bonding in order to hang such articles. In many embodiments, the hanging device may further comprise at least one aperture. At least one aperture in the hanging device may be used to secure the article in conjunction with the additional packaging component. In some embodiments, the hanging device may also be constructed of multiple parts that are interconnected to one another using a fastener or another additional packaging component. Although a non-limiting example, an exemplary hook is shown in FIG. 2. The hook may allow the hanging of an article from a fixture. In some embodiments, the fixture may be a rail, peg, rack, rod, hook, post, or other support upon which hanging device may be hung or attached.

### Hanger

In other embodiments, the hanging device may be a hanger. A hanger, as described herein comprises both: (a) a hook, as described above, and (b) a means for an article to hang onto the hanging device without the use of the additional packaging component. Although a non-limiting example, an exemplary hook is shown in FIG. 5. In many embodiments, the hanger may comprise a first portion, an opening, and a second portion. In some embodiments, the central portion further comprises a first arm and a second arm. In some embodiments, the hanger further comprises at least one aperture. At least one aperture in the hanging device may be used to secure the article in conjunction with the additional packaging component. In many embodiments, the additional packaging component may include but is not limited to fasteners or adhesive bonding means. In some embodiments, the hanging device may also be constructed of multiple parts that are interconnected to one another using a fastener or another additional packaging component.

Further, in some embodiments, the hanging device of the present invention could, in any one embodiment, may comprise one or more of the following: one or more hook portions, indentations, fold lines, slots, channels, tabs, and arms. Nonetheless, the various examples described herein are for illustration purposes only and must not be construed as design limitations.

### Laminate Adhesives

The hanging device described herein may further comprise adhesives. The use of adhesives may improve the overall strength, longevity, performance, and aesthetic characteristics of the hanging device. In many embodiments, the hanging device comprises the first outer liner, the at least one inner layer, and the second outer liner that may be laminated together using a laminate adhesive. In many embodiments, the laminate adhesive is positioned between the first outer liner and the at least one inner layer. In many embodiments, the laminate adhesive is positioned between the second outer liner and the at least one inner layer. In many embodiments, the laminate adhesive is comprised of at least one of the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive. In some embodiments, the laminate adhesive is comprised of a pressure sensitive adhesive. In some embodiments, at least one additional laminate adhesive may be used. In some embodiments, at least one additional laminate adhesive may be different than the laminate adhesive used.

In some embodiments, the laminate adhesive may have a thickness of 1 mil to 250 mils (0.0254 mm to 6.35 mm). In another embodiment, the laminate adhesive may have a thickness of 1 mil to 100 mils (0.0254 mm to 2.54 mm). In yet another embodiment, the laminate adhesive may have a thickness of 1 mil to 10 mils (0.0254 mm to 0.254 mm).

### Coatings

In many embodiments, the hanging device further comprises a coating at least partially disposed on at least one of the first outer liner or the second outer liner. In many embodiments, the coatings may improve the overall strength and aesthetic characteristics of the hanging device. In some embodiments, the coating may provide color-enhancing coatings. In many embodiments, the coating may protect the liner from heat, cold, and moisture. In many embodiments, the coating may protect the liner from ripping, tearing, and other mechanical destruction. In some embodiments, the first outer liner of the hanging device may further comprise at least one additional coating. In some embodiments, the second outer liner of the hanging device may further comprise at least one additional coating. In many embodiments, the coating is comprised of at least one of the following: (a) a pigment; (b) a binder; and (c) optical brightening agent. In one embodiment, the coating may comprise a color optimizing agent to improve the aesthetic characteristics of the hanging device.

In some embodiments, the coating may have a thickness of 1 mil to 100 mils (0.0254 mm to 2.54 mm). In another embodiment, the coating may have a thickness of 1 mil to 50 mils (0.0254 mm to 1.27 mm). In yet another embodiment, the coating may have a thickness of 1 mil to 10 mils (0.0254 mm to 0.254 mm).

### Properties

In many embodiments, the hanging device is comprised of a biobased material. As described herein, biobased materials may refer to products that mainly consist of at least one substance derived from living matter that occur naturally. In one embodiment, the hanging device described herein is comprised of at least 50% biobased material. In one embodiment, the hanging device described herein is comprised of at least 60% biobased material. In one embodiment, the hanging device described herein is comprised of at least 70% biobased material. In one embodiment, the hanging device described herein is comprised of at least 80% biobased material. In one embodiment, the hanging device described herein is comprised of at least 90% biobased material. In one embodiment, the hanging device described herein is comprised of at least 93% biobased material. In one embodiment, the hanging device described herein is comprised of at least 95% biobased material. In one embodiment, the hanging device described herein is comprised of at least 97% biobased material. In one embodiment, the hanging device described herein is comprised of at least 99% biobased material. The use of such biobased materials provides a more sustainable material in which the hanging device may be produced.

In many embodiments, the hanging device is comprised of a recycled material. As defined herein, recycled materials may be waste materials derived from sources of previous articles or other products. Recycled materials may be processed into new materials and products. In many embodiments, the hanging device is comprised of substantially recycled material. In one embodiment, the hanging device described herein is comprised of at least 50% recycled material. In one embodiment, the hanging device described herein is comprised of at least 60% recycled material. In one embodiment, the hanging device described herein is comprised of at least 70% recycled material. In one embodiment, the hanging device described herein is comprised of at least 80% recycled material. In one embodiment, the hanging device described herein is comprised of at least 90% recycled material. In one embodiment, the hanging device described herein is comprised of at least 93% recycled material. In one embodiment, the hanging device described herein is comprised of at least 95% recycled material. In one embodiment, the hanging device described herein is comprised of at least 97% recycled material. In one embodiment, the hanging device described herein is comprised of at least 99% recycled material. The use of recycled materials provides a more sustainable material in which the hanging device may be produced.

In many embodiments, the hanging device is biodegradable. Such biodegradable features may be environmentally friendly. As defined herein, biodegradable means that a material may substantially decomposed by bacteria or other living creatures and a breakdown of the organic matter of the material occurs. In many embodiments, the hanging device described herein is substantially biodegradable. In one embodiment, the hanging device described herein is at least 80% biodegradable. In one embodiment, the hanging device described herein is at least 90% biodegradable. In one embodiment, the hanging device described herein is at least 95% biodegradable. In one embodiment, the hanging device described herein is at least 97% biodegradable. In one embodiment, the hanging device described herein is at least 99% biodegradable. The use of biodegradable materials provides a more sustainable material in which the hanging device may be produced.

### FIGURES

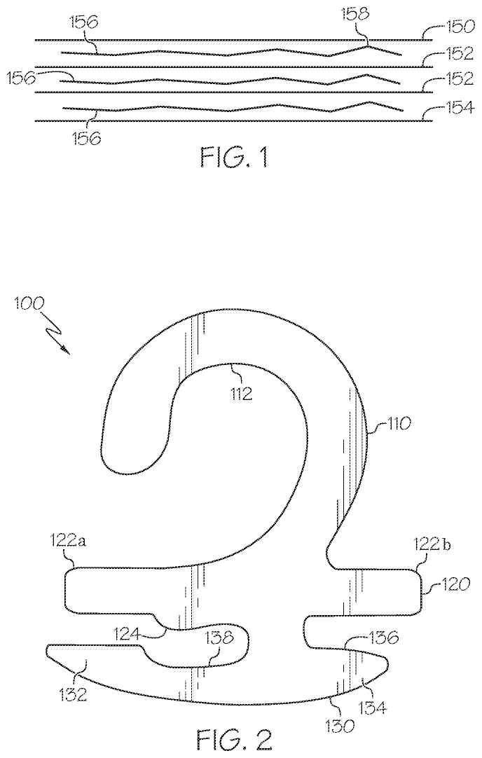

With reference to the drawings, FIG. 1 provides one embodiment of the hanging device 100 in which multiple layers are laminated together. The layers of the hanging device 100 may comprise the first outer liner 150, the at least one inner layer 152, and the second outer liner 154. Specifically in FIG. 1, there are two inner layers 152 shown (both identified as 152). However, this figure is for illustrative purposes only. The at least one inner layer 152 would be included for the hanging device described herein, and the at least one inner layer may be shown as only one inner layer or more than two inner layers although they are not illustrated herein. For the hanging device 100, the one or more inner layers 152 are sandwiched or positioned between said first outer liner 150 and second outer liner 154. The first outer liner 150, the at least one inner layer 152, and the second outer liner 154 may be comprised of pulp board, paper board, corrugated fiber board, mat board, paper board, kraft paper, kraft board, cardstock, vellum, newsprint, wax impregnated papers, cardboard, cellulose fibers, or combinations thereof.

Further, the first outer liner 150, the at least one inner layer 152, and the second outer liner 154 are fixedly laminated together before being die cut into a desired size, shape and orientation. The lamination process may include the use of adhesives 156 to further secure the at least one inner layer 152 with the first outer liner 150 and the second outer liner 154 and to add additional strength to hanging device 100. Laminate adhesives 156 may be comprised of, but are not limited to the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive. the laminate adhesive is comprised of a pressure sensitive adhesive.

With respect to production, fibrous material may first be turned into pulp and bleached to create each of one or more of the first outer liner 150, the at least one inner layer 152, and the second outer liner 154, which can be optionally coated for an improved appearance, especially to the surface of the first outer liner 150 and the second outer liner 154.

Additionally, in one embodiment, each of the first outer liner 150, the at least one inner layer 152, and the second outer liner 154 are integrally formed and have substantially the same shape and size. In other embodiments not shown in the figures, the first outer liner 150, the at least one inner layer 152, and the second outer liner 154 may have different shapes and sizes to conform to a specified application.

Further, first outer liner 150 and the second outer liner 154 may further comprise a coating 158 to improve the various appearance qualities, including but not limited to the color, smoothness, and/or gloss of the first outer liner 150 and the second outer liner 154. In some embodiments, the coating 158 may be comprised of at least one of the following: (a) a pigment; (b) a binder; and (c) optical brightening agent. In one embodiment, the coating 158 may be comprised of one or more of the following: (a) a pigment, such as clay, calcium carbonate, titanium dioxide, or a combination of the same; (b) a binder such as styrene-butadiene emulsions or starches and water; and (c) an optical brightening agent. Notwithstanding the forgoing, other suitable materials and coatings could also be used to create at least one of the first outer liner 150, the at least one inner layer 152, and the second outer liner 154 depending on user need and preference, or the needs of the particular application.

Once assembled, the hanging device 100 may have a thickness between 70 and 140 points, where 254 points typically equates to 2.54 cm (one inch). In another embodiment, the hanging device 100 may have a thickness between 84 and 126 points. In yet another embodiment, the hanging device 100 may have a thickness between 95 and 120 points.

In some embodiments, the ratios of thickness with respect to the various layers/liners of hanging device 100 are between 5%-25% for each of first outer liner 150 and the second outer liner 154. In some embodiments, the ratios of thickness with respect to the various layers/liners of hanging device 100 are between 10%-20% for each of first outer liner 150 and the second outer liner 154. In some embodiments, the ratios of thickness with respect to the various layers/liners of hanging device 100 are between 15%-20% for each of first outer liner 150 and the second outer liner 154. In some embodiments, the ratios of thickness with respect to the various layers/liners of hanging device 100 are between 60-90% for the inner layer 152 in a three-layer lamination construction (having a first outer liner 150, one inner layer 152, and one outer liner 154). In some embodiments, the ratios of thickness with respect to the various layers/liners of hanging device 100 are between 60-80% for the inner layer 152 in a three-layer lamination construction (having a first outer liner 150, one inner layer 152, and one outer liner 154). In some embodiments, the ratios of thickness with respect to the various layers/liners of hanging device 100 are between 60-70% for the inner layer 152 in a three-layer lamination construction (having a first outer liner 150, one inner layer 152, and one outer liner 154).

In an embodiment where a four-layer lamination construction is used, the ratios of thickness with respect to the various layers/liners of hanging device 100 are between 10%-20% for each of first outer liner 150 and the second outer liner 154 and 60%-80% for the two inner layers. In an embodiment where a four-layer lamination construction is used, the ratios of thickness with respect to the various layers/liners of hanging device 100 are between 15%-20% for each of first outer liner 150 and the second outer liner 154 and 60%-70% for the two inner layers. Notwithstanding, the above ranges are offered as examples and not limitations, and additional thicknesses and thickness percentages by layer/liner are also contemplated.

FIG. 2 illustrates a perspective view of one potential embodiment of a hanging device 100 described herein. In this particular embodiment, the hanging device 100 is a hook. In general, the hanging device of FIG. 2 is generally comprised of a first portion 110 and a central portion 120. The first portion 110 is generally hook shaped to form an opening 112 for receipt of a rail, peg, rack, rod, hook, post, or other support (not shown) upon which hanging device 100 may be hung or attached to. The first portion 110 may extend to the central portion 120. The hook may allow the hanging of an article from a fixture.

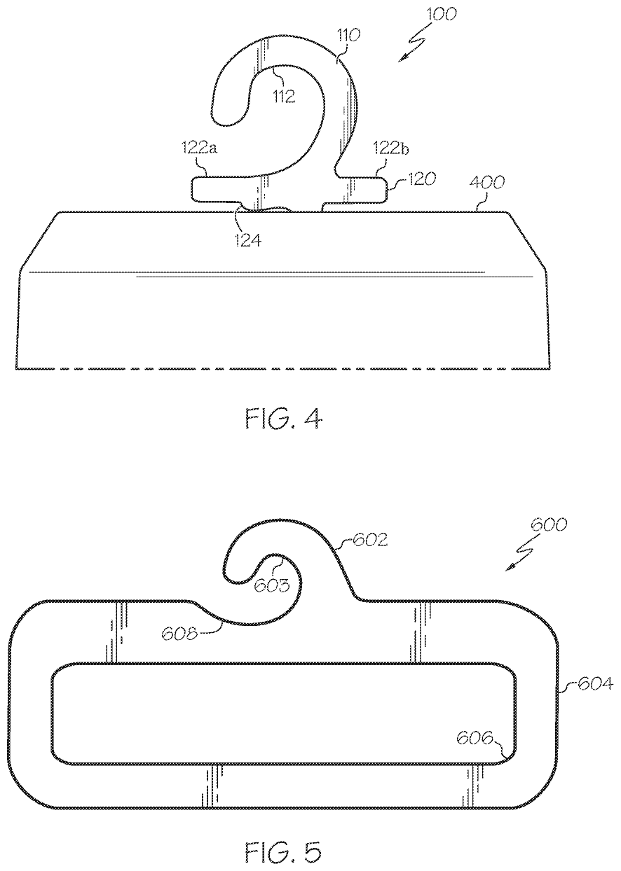

In many embodiments, the central portion 120 further comprises a first arm 122a and a second arm 122b. The central portion 120 may be generally rectangular in shape and have two opposing arms, namely a first arm 122a and a second arm 122b, that extend outwardly from where central portion 120 intersects with first portion 110, as shown in FIG. 2. A first arm 122a and a second arm 122b may be useful for providing additional strength to hanging device 100, and for retaining an article of clothing or packaging 400, as shown in FIG. 4. The central portion 120 may optionally further comprise at least one protrusion 124 that extends outwardly from central portion 120. At least one protrusion 124 may also be useful for securing hanging device 100 to packaging 400, by contacting and/or applying pressure to the same, as also shown in FIG. 4.

In an optional embodiment shown in FIG. 2, the hanging device may comprise a second portion 130, which is a generally elongated member having a first end 132 and a second end 134. Each of first end 132 and second end 134 extend outwardly from where second portion 130 intersects with central portion 120. Opposing first end 132 and the second end 134 may also be useful for providing additional strength to hanging device 100, and for retaining an article of clothing or packaging 400. More specifically, first end 132 is generally hook shaped and extends outwardly from where central portion 120 and second portion 130 intersect. First end 132, along with the presence of first arm 122a, also forms a slot or opening 138 in hanging device 100 which may be useful for retaining packaging 400, as shown in FIG. 4. Similarly, second end 134 also extends outwardly from where central portion 120 and second portion 130 intersect, and in a direction opposite of first end 132. Second end 134, along with the presence of second arm 122b, also forms a slot or opening 136 in hanging device 100 which may be useful for retaining packaging 400, as shown in FIG. 4.

Notwithstanding, and as illustrated throughout and further explained below, hanging device 100 can be any suitable size, shape, and/or configuration as is known in the art without affecting the overall concept of the hanging device 100 described herein. One of ordinary skill in the art will appreciate that the shape, size and configuration of hanging device 100 shown in FIG. 2 as well as the various other embodiments shown in the embodiments depicted in the various other FIGS. are for illustrative purposes only, and that many other shapes and sizes of hanging device 100 are well within the scope of the present disclosure. Although the dimensions of the hanging device 100 (i.e., length, width, and height) are important design parameters for good performance, the hanging device 100 may be any shape, size or configuration that ensures optimal performance during use and satisfies user need or preference.

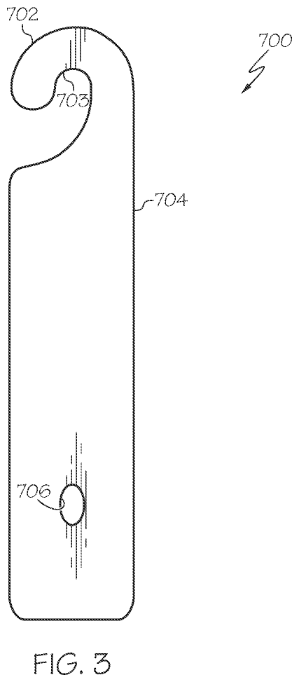

FIG. 3 illustrates a perspective view of an alternative embodiment of a hanging device 700 in accordance with the disclosed architecture, and that can be used to support and exhibit an article (not shown), such as an article of clothing. More specifically, hanging device 700 may be comprised of a first portion 702 and a second portion 704. First portion 702 is generally hook shaped to form an opening 703 for receipt of a rail, peg, rack, rod, hook, post, or other support (not shown) upon which hanging device 700 may be hung or attached. The first portion 702 extends to second portion 704. In many embodiments, the second portion 704 is generally rectangular in shape and has an opening 706 therein for receipt of an article. Further, hanging device 700 may be comprised of the first outer liner 150, the at least one inner layer 152, and/or second outer liner 154 of hanging device 100 described above in FIG. 1, including the use of adhesive 156 and/or coating 158, or a similar arrangement or configuration.

FIG. 4 illustrates an alternative embodiment of the hanging device 100 of FIG. 2. FIG. 4 provides the hanging device 100 used in connection with a paperboard package 400 to support an article. The paperboard package 400 may be used to support articles such as, but not limited to, socks, scarves, hosiery, hair accessories, ties, undergarments, footwear, glasses, belts, and other clothing. The hanging device 100 may be positioned in a selectable opening or slot after paperboard accessory is wrapped around or supports at least one article. Paperboard package 400 may be comprised of the same laminated first outer liner 150, the at least one inner layer 152, and the second outer liner 154 of hanging device 100 described above, including the use of adhesive 156 and/or coating 158, or a similar arrangement or configuration.

In many embodiments, the central portion 120 further comprises a first arm 122a and a second arm 122b. The central portion 120 may be generally rectangular in shape and have two opposing arms, namely a first arm 122a and a second arm 122b, that extend outwardly from where central portion 120 intersects with first portion 110, as shown in FIG. 2. A first arm 122a and a second arm 122b may be useful for providing additional strength to hanging device 100, and for retaining an article of clothing or packaging 400, as shown in FIG. 4. The central portion 120 may optionally further comprise at least one protrusion 124 that extends outwardly from central portion 120. At least one protrusion 124 may also be useful for securing hanging device 100 to packaging 400, by contacting and/or applying pressure to the same, as also shown in FIG. 4.

For example, as shown in FIG. 4, the portion of hanging device 100 that transitions between central portion 120 and second portion 130 may be positioned in an opening or slot in the paperboard package 400 after the paperboard package 400 has been formed as described above. Further, the presence of at least one protrusion 124 may be useful for securing hanging device 100 to package 400, by contacting and/or applying pressure to the same, as also shown in FIG. 4.

FIG. 5 illustrates a perspective view of an alternative embodiment of a hanging device 600 in accordance with the disclosed architecture, and designed for use with an article, including an article of clothing such as sock, pants, or leggings (not shown). In FIG. 5, the hanging device 600 is a hanger. For FIG. 5, the hanging device shown comprises a first portion 602, an opening 606, and a second portion 604. The first portion 602 is generally hook shaped to form an opening 603 for receipt of a rack, rod or other support (not shown) upon which hanging device 600 may be hung or attached to. Additionally, the first portion 602 extends to second portion 604.

Second portion 604 is generally rectangular in shape and has a generally rectangular opening 606 therein for receipt of an article of clothing such as, but not limited to socks, pants, leggings, or the like. As shown in FIG. 5, the surface of second portion 604 just opposite the hook portion of first portion 602 may further comprise an indentation or depression 608 to make it easier for the user to place or remove hanging device 600 from a fixture. In some embodiments, the fixture may be a rail, peg, rack, rod, hook, post, or other support upon which hanging device 600 may be hung or attached.

Further, hanging device 600 of FIG. 5 may be comprised of the same laminated first outer liner 150, the at least one inner layer 152, and second outer liner 154 of hanging device 100 described above in FIG. 1, including the use of adhesive 156 and/or coating 158, or a similar arrangement or configuration.

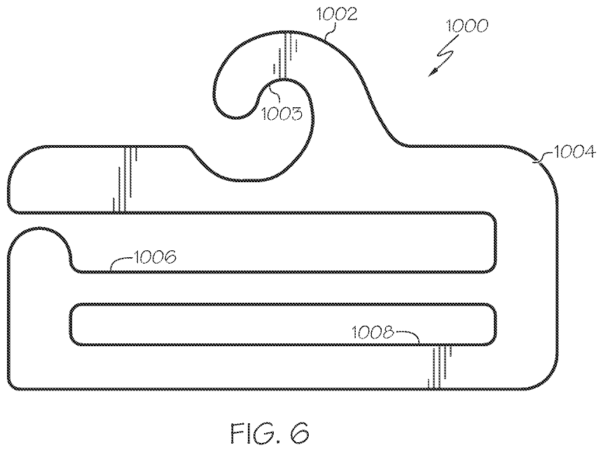

FIG. 6 illustrates a perspective view of an alternative embodiment of a hanging device 1000 in accordance with the disclosed architecture. In particular, the hanging device in FIG. 6 may be designed for use with a neck tie or similar article of clothing or accessory (not shown). More specifically, hanging device 1000 is comprised of a first portion 1002 and a second portion 1004. First portion 1002 is generally hook shaped to form an opening 1003 for receipt of a rack, rod or other support (not shown) upon which hanging device 1000 may be hung or attached to. First portion 1002 extends to second portion 1004.

Second portion 1004 may be generally rectangular in shape with a slot 1006 and a continuous opening 1008 formed therein for receiving an article such as an article of clothing, like a neck tie, a belt, a pair of socks, or the like. Further, hanging device 1000 may be comprised of the same laminated first outer liner 150, the at least one inner layer 152, and the second outer liner 154 of hanging device 100 described above, including the use of adhesive 156 and/or coating 158, or a similar arrangement or configuration.

A method of assembling the hanging device of Embodiment 1. The hanging device of any of the embodiments described herein may also be assembled using the method described. The hanging device comprising: a) a first outer liner; b) at least one inner layer; and c) a second outer liner may be assembled such that it is laminated together. For the hanging device assembly, the first outer liner is at least partially disposed on the at least one inner layer and the second outer liner is at least partially disposed on the at least one inner layer, and then the first outer liner, the at least one inner layer, and the second outer liner are laminated together. The lamination process may be accomplished through the use of an adhesive.

The following are example embodiments of the disclosure with the understanding that further example embodiments may be provided in accordance with the disclosure. Furthermore, any of the embodiments discussed below may be used alone or in combination with any of the other embodiments discussed below.

Embodiment 1. A hanging device may comprise: (a) a first outer liner; (b) at least one inner layer; and (c) a second outer liner; wherein the first outer liner is at least partially disposed on the at least one inner layer; wherein the second outer liner is at least partially disposed on the at least one inner layer; wherein the first outer liner, the at least one inner layer, and the second outer liner are laminated together; and wherein the hanging device is a hook or a hanging device.

Embodiment 2. The hanging device of Embodiment 1, wherein the first outer liner, the at least one inner layer, and the second outer liner comprises pulp board, paper board, corrugated fiber board, mat board, paper board, kraft paper, kraft board, cardstock, vellum, newsprint, wax impregnated papers, cardboard, cellulose fibers, or combinations thereof.

Embodiment 3. The hanging device of Embodiment 1, wherein the first outer liner, the at least one inner layer, and the second outer liner are laminated together using a laminate adhesive

Embodiment 4. The hanging device of Embodiment 3, wherein the laminate adhesive is positioned between the first outer liner and the at least one inner layer.

Embodiment 5. The hanging device of Embodiment 3, wherein the laminate adhesive is positioned between the second outer liner and the at least one inner layer.

Embodiment 6. The hanging device of Embodiment 3, wherein the laminate adhesive is comprised of at least one of the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive.

Embodiment 7. The hanging device of Embodiment 3, wherein the laminate adhesive is comprised of a pressure sensitive adhesive.

Embodiment 8. The hanging device of Embodiment 1, wherein the hook comprises a first portion and a central portion.

Embodiment 9. The hanging device of Embodiment 8, wherein the central portion further comprises a first arm and a second arm.

Embodiment 10. The hanging device of Embodiment 1, wherein the hanger comprises a first portion, an opening, and a second portion.

Embodiment 11. The hanging device of Embodiment 1, further comprising at least one aperture.

Embodiment 12. The hanging device of Embodiment 1, further comprising at least one protrusion.

Embodiment 13. The hanging device of Embodiment 1, wherein the first outer liner, the at least one inner layer, and the second outer liner are substantially the same shape.

Embodiment 14. The hanging device of Embodiment 1, further comprising a coating at least partially disposed on at least one of the first outer liner or the second outer liner.

Embodiment 15. The hanging device of Embodiment 14, wherein the coating is comprised of at least one of the following: (a) a pigment; (b) a binder; and (c) optical brightening agent.

Embodiment 16. The hanging device of Embodiment 1, wherein the hanging device is comprised of a biobased material.

Embodiment 17. The hanging device of Embodiment 1, wherein the hanging device is comprised of a recycled material.

Embodiment 18. The hanging device of Embodiment 1, wherein the hanging device is biodegradable.

Embodiment 19. A method of assembling the hanging device of Embodiment 1.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A hanging device comprising:
a first outer liner;
at least one inner layer; and
a second outer liner;
wherein the first outer liner is at least partially disposed on the at least one inner layer;
wherein the second outer liner is at least partially disposed on the at least one inner layer;
wherein the first outer liner, the at least one inner layer, and the second outer liner are laminated together; and
wherein the hanging device is a hook or a hanger.

2. The hanging device of claim 1 wherein the first outer liner, the at least one inner layer, and the second outer liner comprises pulp board, paper board, corrugated fiber board, mat board, paper board, kraft paper, kraft board, cardstock, vellum, newsprint, wax impregnated papers, cardboard, cellulose fibers, or combinations thereof.

3. The hanging device of claim 1 wherein the first outer liner, the at least one inner layer, and the second outer liner are laminated together using a laminate adhesive.

4. The hanging device of claim 3, wherein the laminate adhesive is positioned between the first outer liner and the at least one inner layer.

5. The hanging device of claim 3, wherein the laminate adhesive is positioned between the second outer liner and the at least one inner layer.

6. The hanging device of claim 3, wherein the laminate adhesive is comprised of at least one of the following: (a) a hot melt adhesive; (b) a water based adhesive; (c) a solvent based adhesive; (d) an acrylic adhesive; (e) an epoxy adhesive; (f) a rubber adhesive; (g) a silicone adhesive; and (h) a polyurethane adhesive.

7. The hanging device of claim 3, wherein the laminate adhesive is comprised of a pressure sensitive adhesive.

8. The hanging device of claim 1 wherein the hook comprises a first portion and a central portion.

9. The hanging device of claim 8 wherein the central portion further comprises a first arm and a second arm.

10. The hanging device of claim 1 wherein the hanger comprises a first portion, an opening, and a second portion.

11. The hanging device of claim 1 wherein the hanging device further comprises at least one aperture.

12. The hanging device of claim 1 wherein the hanging device further comprises at least one protrusion.

13. The hanging device of claim 1, wherein the first outer liner, the at least one inner layer, and the second outer liner are substantially the same shape.

14. The hanging device of claim 1 further comprising a coating at least partially disposed on at least one of the first outer liner or the second outer liner.

15. The hanging device of claim 14, wherein the coating is comprised of at least one of the following: (a) a pigment; (b) a binder; and (c) optical brightening agent.

16. The hanging device of claim 1, wherein the hanging device is comprised of a biobased material.

17. The hanging device of claim 1, wherein the hanging device is comprised of a recycled material.

18. The hanging device of claim 1, wherein the hanging device is biodegradable.

19. A method of assembling the hanging device of claim 1.
